(19) United States
(12) Patent Application Publication
(10) Pub. No.: US 2019/0050810 A1
(43) Pub. Date: Feb. 14, 2019

(54) TERMINAL AUTOMATION SOLUTIONS SUPPORTING BLOCKCHAIN TECHNOLOGY

(71) Applicant: Honeywell International Inc., Morris Plains, NJ (US)

(72) Inventors: Narendra K. V. Nagalla, Bangalore (IN); Soundari Arunachalam, Bangalore (IN); Nagaraja Sundaresh, Hyderabad (IN); Sumanth P. Lingesh, Bangalore (IN); Nagabhushan D. Rahut, Bangalore (IN)

(21) Appl. No.: 15/973,700

(22) Filed: May 8, 2018

Related U.S. Application Data
(60) Provisional application No. 62/544,972, filed on Aug. 14, 2017.

(51) Int. Cl. G06Q 10/08; G06F 17/30

(52) U.S. Cl. CPC G06Q 10/0838; H04L 9/0643; G06F 17/30345

(57) ABSTRACT

A method includes obtaining data associated with at least one of: one or more products stored in or transferred via a first cargo distribution terminal, one or more actions occurring in the first cargo distribution terminal, and one or more personnel associated with the first cargo distribution terminal or the one or more products. The method also includes generating an update to a blockchain based on the data and updating a local copy of the blockchain using the update. The method further includes publishing the update to one or more nodes for updating one or more additional copies of the blockchain. The update could identify that at least a portion of the one or more products has been received at or shipped from the first cargo distribution terminal. The update could identify information about a vehicle used to transport the one or more products or a driver of the vehicle.

### CROSS-REFERENCE TO RELATED APPLICATION AND PRIORITY CLAIM

This application claims priority under 35 U.S.C. § 119(e) to U.S. Provisional Patent Application No. 62/544,972 filed on Aug. 14, 2017. This provisional application is hereby incorporated by reference in its entirety.

### TECHNICAL FIELD

This disclosure generally relates to mechanisms for secure and reliable communication of information involving cargo distribution terminals, such as in oil and gas distribution terminals or in other product distribution systems. More specifically, this disclosure relates to terminal automation solutions supporting blockchain technology.

### BACKGROUND

Throughout history, the shipment and distribution of goods have been essential. Movement of goods from one location to another often involves the loading or unloading of cargo at distribution terminals, such as warehouses, ports, or storage terminals. The cargo is unloaded from and loaded onto cargo transporting vehicles, such as trucks, trains, and ships.

Due to the frequent arrival and departure of many cargo transporting vehicles and a limited number of cargo bays, some distribution terminals have deployed terminal automation systems. These terminal automation systems are typically designed to manage and schedule the loading and unloading of cargo involving numerous cargo transporting vehicles. However, these terminal automation systems are often implemented using hardware devices and software solutions hosted locally, with no interaction with other terminals.

### SUMMARY

This disclosure provides terminal automation solutions supporting blockchain technology.

In a first embodiment, a method includes obtaining data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products. The method also includes generating an update to a blockchain based on the data and updating a local copy of the blockchain using the update. The method further includes publishing the update to one or more nodes for updating one or more additional copies of the blockchain.

In a second embodiment, an apparatus includes at least one memory configured to store data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products. The apparatus also includes at least one processor configured to generate an update to a blockchain based on the data, update a local copy of the blockchain using the update, and publish the update to one or more nodes for updating one or more additional copies of the blockchain.

In a third embodiment, a non-transitory computer readable medium contains instructions that when executed cause at least one processor to obtain data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products. The medium also contains instructions that when executed cause the at least one processor to generate an update to a blockchain based on the data, update a local copy of the blockchain using the update, and publish the update to one or more nodes for updating one or more additional copies of the blockchain.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example blockchain supporting terminal automation solutions in accordance with this disclosure;

FIG. 2 illustrates an example functional architecture for using blockchains supporting terminal automation solutions in accordance with this disclosure;

FIG. 3 illustrates an example system of cargo distribution terminals that receive cargo from or provide cargo to a number of cargo vehicles in accordance with this disclosure;

FIG. 4 illustrates an example device supporting blockchain technology for terminal automation solutions in accordance with this disclosure;

FIGS. 5 through 10 illustrate example graphical user interfaces based on blockchains supporting terminal automation solutions in accordance with this disclosure; and

FIG. 11 illustrates an example method for using blockchains to support terminal automation solutions in accordance with this disclosure.

### DETAILED DESCRIPTION

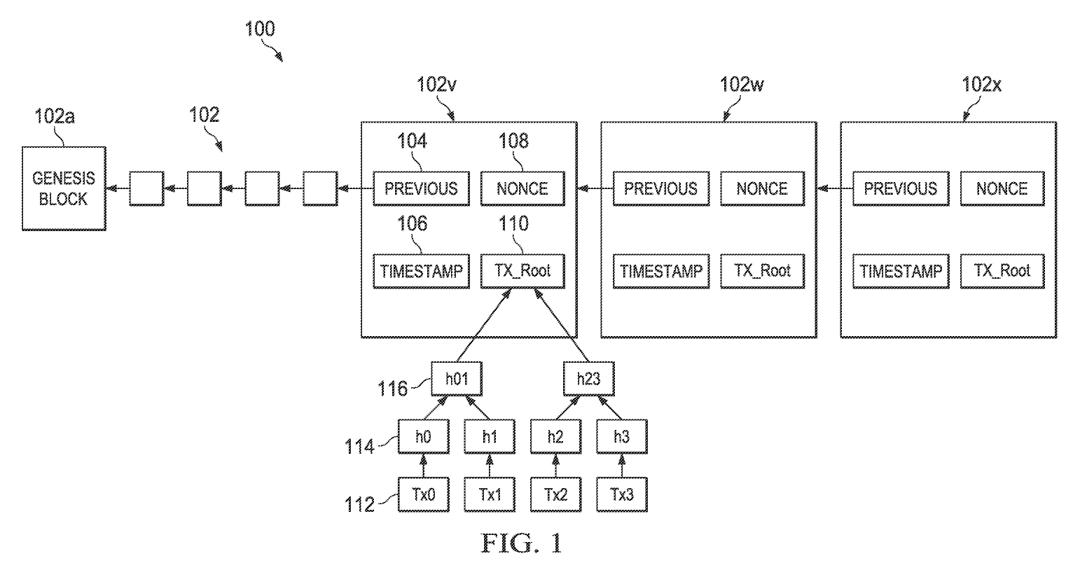

FIGS. 1 through 11, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

As noted above, cargo distribution terminals (such as warehouses, ports, or storage terminals) typically receive cargo from and deliver cargo to many cargo transporting vehicles (such as trucks, trains, or ships). Due to frequent arrivals and departures of many cargo transporting vehicles and a limited number of cargo bays, some distribution terminals have deployed terminal automation systems designed to manage and schedule the loading and unloading of cargo. However, terminal automation systems are often implemented using hardware devices and software solutions hosted locally without any interactions with other terminals.

Terminal owners and operators may rely heavily on the trust and transparency built among multiple stakeholders, such as shareholders, terminal owners, terminal operators, carrier companies, and terminal customers. Currently, different stakeholders have different systems and databases at every stage, and there is no automated synchronization happening across these systems. Manual interactions between untrusted parties make the supply chain less efficient and can result in higher operational costs.

As particular examples, it is currently difficult for the owners or operators of multiple distribution terminals to exchange information about truck drivers who enter and exit their terminals in order to drop off or pick up cargo. Product pilferage during transfers in trucks can result in huge losses for customers, but it is difficult for terminal owners or operators to exchange information about drivers who may be engaging in or allowing pilferage. Also, drivers who deviate from standard operating procedures (SOPs) at the gantries of terminals can create safety issues inside the terminals, but it is difficult for owners or operators of some terminals to obtain information identifying improper driver behaviors at other terminals. Further, the inability to track driver or vehicle activities can prevent identification of the drivers' overall performance across different terminals. In addition, the lack of stock reconciliation can reduce transparency to customers, particularly when those customers have products that are stored in comingling tanks (meaning multiple customers' products are stored in the same tank).

In accordance with this disclosure, various techniques are provided for using one or more blockchains to store information used with terminal automation solutions. For example, the blockchains can be used to store information about terminal operations and cargo stored in one or more terminals. The blockchains can also be used to store information about suppliers that provide the cargo, carrier companies that transport the cargo, and customers who receive the cargo. The blockchains can further be used to store information about specific drivers or vehicles used to transport the cargo. Among other things, having this data available in one or more blockchains allows terminals, their customers, and other parties to be connected more reliably and allows them to share useful and valid information across terminals. This helps to establish and increase trust among the various parties involved in cargo distribution operations. It also makes this data easily available for use by any interested party associated with the cargo distribution operations.

FIG. 1 illustrates an example blockchain 100 supporting terminal automation solutions in accordance with this disclosure. A “blockchain” generally refers to a distributed ledger of transactions, where various parties have access to the distributed ledger. The parties can use the distributed ledger to perform various functions, such as publishing new transactions to the blockchain or using the blockchain to verify ownership of something. New transactions are added as blocks to a blockchain using cryptographic operations, and each block in the blockchain (except the first block) is linked to a previous block in the blockchain. Approval by a majority of parties is generally needed to add transactions to the blockchain or to verify ownership.

As shown in FIG. 1, the blockchain 100 includes a sequence of blocks 102a-102x (which are referred to generally as blocks 102). Each block 102 functions as a record associated with a specific transaction. As described in more detail below, each transaction represented by a block 102 in the blockchain 100 is associated in some way with a terminal automation solution. For example, one or more blocks 102 in the blockchain 100 could represent cargo stored in, being transferred to, or being transferred from one or more distribution terminals. As another example, one or more blocks 102 in the blockchain 100 could represent information about drivers or vehicles used to transfer cargo to or from one or more distribution terminals. As yet another example, one or more blocks 102 in the blockchain 100 could represent at least one smart contract between parties associated with cargo. Of course, the blocks 102 could be associated with any other transactions related to terminal automation.

Except for the first block 102a in the blockchain 100, each block 102 includes a previous hash value 104, which represents a cryptographic hash from the previous block 102 in the blockchain 100. Each block 102 also includes a timestamp 106, which identifies the date and time that the associated block 102 was created. Each block 102 further includes a nonce value 108, which represents a value that is added to the block 102 by the party who created the block 102. The nonce value 108 provides proof to other parties that the party who created the block 102 performed certain cryptographic operations in order to generate a valid block 102, where the other parties can easily verify the validity of the block 102 using the nonce value 108.

In addition, each block 102 includes transaction data, which includes a transaction root hash value 110. The transaction root hash value 110 in each block 102 represents a hash value generated by the party who created that block 102 based on transaction information. In this example, the transaction root hash value 110 in each block 102 can be generated by taking data 112 associated with one or more transactions (such as actual data or metadata describing the transactions) and applying one or more hashing functions using the data 112. This generates one or more hash values 114. Assuming there are multiple hash values 114, one or more additional hashing functions (such as pairwise hashing functions) can be applied to the hash values 114 in order to generate one or more additional hash values 116. An additional hashing function could then be applied to the hash values 116 in order to generate the root hash value 110. The root hash value 110 here represents the “Merkle root” of the data 112. Note that this represents one example of how the transaction root hash value 110 could be generated. In general, the root hash value 110 could be generated in any suitable manner, as long as the root hash value 110 represents a cryptographic hash of most or all of the block 102. As noted above, the transaction associated with each block 102 relates in some way to terminal automation, such as when the block 102 contains data about cargo, smart contracts associated with cargo, and/or drivers or vehicles that transport cargo.

In one aspect of operation, multiple “local” copies of the blockchain 100 are stored and maintained by multiple computing nodes, each of which is accessible by one or more (and typically all) of the parties associated with the blockchain 100. The blockchain 100 therefore functions as a distributed ledger that can be used by multiple parties to obtain or verify information contained in the blocks 102 of the blockchain 100. The parties also generate or use transaction data, and cryptographic operations are performed using the transaction data to create and add new blocks 102 to the blockchain 100. Thus, parties can append new blocks 102 to the blockchain 100 at different computing nodes as new transactions occur, and these blocks 102 are propagated to other computing nodes so that the blockchain 100 can be updated at those nodes. Each new block 102 is linked to a previous block 102 in the blockchain 100 as described above, which helps to prevent someone from illicitly changing data in earlier blocks 102 of the blockchain 100. Approval of a majority of the parties may be required before each new block 102 is added to the blockchain 100.

In the context of terminal automation, blockchains 100 can be used to support various functions. For example, blockchains 100 could be used to store information about cargo passing through or stored at one or more distribution terminals and about people and vehicles used to transport the cargo. Using blockchains 100 as a storage location for information about cargo and people/vehicles can help parties distribute and transport cargo more efficiently. As a particular example, parties could use the contents of one or more blockchains 100 to identify drivers who may be pilfering products being transported on their trucks or allowing it to happen. As another particular example, parties could use the contents of one or more blockchains 100 to identify drivers who engage in misbehaviors that can lead to safety risks and revenue losses to terminals, such as by deviating from standard operating procedures. As yet another particular example, parties could use the contents of one or more blockchains 100 to identify which products stored in one or more terminals belong to which customers, allowing customers to quickly obtain current “on demand” stock availability for the customers' products. Note that these examples are merely meant to illustrate potential ways in which blockchains 100 can be used to support terminal automation functions. Blockchains 100 could be used in any other suitable manner to support terminal automation functions and to share data between multiple parties.

In this way, the blockchain 100 provides a tamper-evident distributed ledger that can be used by multiple parties. This helps to improve the trust among the parties involved in the blockchain 100 over time and eliminates the need to use an intermediary between non-trusting parties. The use of blockchain technology also helps to provide data security and data authenticity. In addition, the use of blockchain technology allows for distributed availability of the data as well as distributed accountability between the parties. The end results from using blockchain technology with terminal automation solutions include reduced operational costs, improved terminal operations, improved speed of business processes, reduced disputes (accuracy improvements), reduced time needed for audits, and availability of real-time stock reconciliation.

In general, any stakeholder associated with cargo being transported or distributed could access and add information to one or more blockchains 100. The following describes examples of the types of stakeholders that could be associated with one or more blockchains 100 in the oil and gas industry. Of course, other or additional stakeholders could be associated with one or more blockchains 100 in the oil and gas industry. Also, the blockchains 100 could be used with any suitable stakeholders in any suitable industries.

In the oil and gas industry, the stakeholders could include shareholders who initially own cargo and who can use at least one blockchain 100 to accurately track shipments, make allocations based on terminal distribution/demand patterns, and generate stock reconciliation reports. Owners of one or more distribution terminals could use at least one blockchain 100 to help reduce or minimize operational costs and increase or maximize revenues while supporting just-in-time (JIT) inventory management using a decentralized information technology (IT) infrastructure. One or more terminal planners could use at least one blockchain 100 to help identify upstream supply patterns and downstream distribution/demand patterns to support JIT inventory management and shareholder allocations/transfer agreements. One or more terminal operators could use at least one blockchain 100 to help digitally identify drivers or other personnel at one or more terminals. One or more governmental authorities could use at least one blockchain 100 during excise taxation procedures, which could help to increase government revenues, provide for tamper-proof auditing and inquiries, and allow penalization of appropriate violations. One or more carrier companies (such as drivers or vehicle providers) could use at least one blockchain 100 to identify their engagement level in one or more terminals and possibly to receive priority during bay allocation at one or more terminals. One or more gas station owners could use at least one blockchain 100 to accurately track incoming cargo shipments and generate stock reconciliation reports, as well as to select one or more carriers or one or more terminals that will be used to provide cargo in the future. One or more end customers (such as gas station customers) could use at least one blockchain 100 to rate gas stations or other vendors with the best service (such as in terms of price, quality, or utilities). Note that these stakeholders and functions are merely examples of how one or more blockchains 100 could be used to support terminal automation functions.

Although FIG. 1 illustrates one example of a blockchain 100 supporting terminal automation solutions, various changes may be made to FIG. 1. For example, the blockchain 100 could include any suitable number of blocks 102 and be used to represent any suitable number of transactions. Also, the contents of the blocks 102 could vary as needed or desired. As a particular example, any suitable blockchain technologies could be used here, including those that determine consensus based on non-mining techniques like proof-of-stake techniques. In those types of approaches, content like the nonce values 108 could be omitted from the blocks 102.

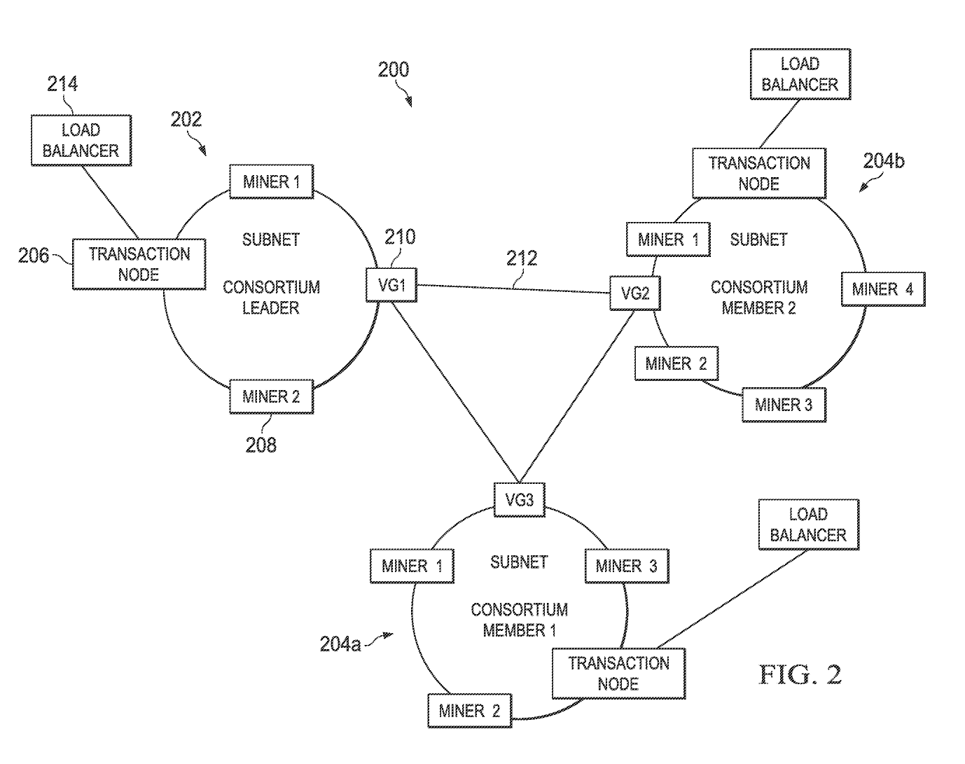

FIG. 2 illustrates an example functional architecture 200 for using blockchains supporting terminal automation solutions in accordance with this disclosure. For ease of explanation, the functional architecture 200 is described as being used by different parties to store information associated with terminal automation in copies of the blockchain 100 of FIG. 1. However, the functional architecture 200 could support the use of any other suitable blockchains.

There are various ways to set up a blockchain, including public, private, and consortium blockchains. Public blockchains are typically available to a large number of users and have been used for cryptographic currencies like BitCoin. When close control is needed, a public blockchain is generally not an option. Private blockchains are typically used by individual companies or other organizations. Consortium (or “permissioned”) blockchains can be used when multiple companies or other organizations are involved, such as when hosting blockchain as a service (BAAS), but when public availability of the ledgers is not needed or desired. In FIG. 2, the functional architecture 200 assumes that one or more blockchains 100 being used by different entities are consortium blockchains. However, this is not necessarily required.

As shown in FIG. 2, the functional architecture 200 is generally associated with different entities, including a consortium leader 202 and one or more consortium members 204a-204b. The consortium leader 202 generally represents an entity responsible for allowing one or more initial consortium members to join a consortium and begin using one or more blockchains 100. Depending on the implementation, the consortium leader 202 or the initial consortium members can then allow additional consortium members to join the consortium and begin using one or more blockchains 100. Each consortium member 204a-204b generally represents an entity that uses one or more blockchains 100 in some way. It should be noted that these designations (consortium leader and consortium member) are used here as a matter of convenience and do not limit the activities that can be performed by these entities. For instance, a consortium leader often represents an entity that uses the blockchains 100 and thus acts like a consortium member. Also, an entity could act as a consortium leader for some blockchains 100 and as a consortium member for other blockchains 100.

Each entity associated with the functional architecture 200 generally operates or has access to its own subnetwork that supports the use of the blockchains 100. Each subnetwork could be formed from a single computing node or multiple computing nodes. Each subnetwork could represent one or more computing nodes owned or operated by the associated entity, or each subnetwork could be implemented virtually (such as in a cloud computing environment) on behalf of the associated entity. The computing nodes here include transaction nodes 206, mining nodes 208, and virtual gateways 210.

Each transaction node 206 generally operates to receive information associated with transactions (such as information related to cargo, smart contracts, drivers, or vehicles) and submit that information to one or more mining nodes 208 for inclusion in one or more suitable blockchains 100. Each mining node 208 generally operates to perform cryptographic operations using the transaction information in order to create new blocks 102 that are added to their local copies of the suitable blockchains 100. Each virtual gateway 210 generally operates to support communications between the various entities over a virtual network 212. Among other things, this allows each mining node 208 to send updates made to its local copy of one or more blockchains 100 to other mining nodes 208, which allows those other mining nodes 208 to update their local copies of the same blockchain(s) 100. Different virtual networks 212 (accessible via a common virtual gateway 210 or different virtual gateways 210) could be used by each entity to support the use of different consortium blockchains.

Each entity can have or use any suitable numbers of transaction nodes 206, mining nodes 208, and virtual gateways 210. In some embodiments, each of the transaction nodes 206, mining nodes 208, and virtual gateways 210 could represent a virtual node or virtual machine that is executed in a computing cloud or on other suitable hardware. In particular embodiments, the transaction nodes 206, mining nodes 208, and virtual gateways 210 could be executed using one or more of MICROSOFT's AZURE, IBM's BLUE MIX, and AMAZON's AWS computing cloud services. This approach allows transaction nodes 206, mining nodes 208, and virtual gateways 210 to be executed and used when needed. However, other approaches could also be used here.

If needed or desired, one or more load balancers 214 could be used to distribute processing loads among the different entities involved in the consortium. This may help to reduce or prevent one entity's actual or virtual computing nodes from being over-burdened while another entity's computing nodes are under-utilized. For example, since different entities may have different numbers of mining nodes 208, entities with more mining nodes 208 may be able to receive and process more requests to add blocks 102 to blockchains 100. In some embodiments, the load balancers 214 may be responsible for passing requests to the transaction nodes 206, so the load balancers 214 could include public Internet Protocol (IP) addresses. The transaction nodes 206 could be accessed using Secure Shell (SSH) or other cryptographic network protocols. This could help to shield the mining nodes 208 so that the mining nodes 208 cannot be accessed remotely.

As described in more detail below, this type of functional architecture 200 can be used by various parties associated with terminal automation. For example, in the oil and gas industry, an oil and gas supply chain can involve numerous parties between the points where oil and gas are extracted from the ground and the points where products are delivered to customers. These parties can include refineries, suppliers, bottling plants, bulk storage terminal operators, governmental and port authorities, bulk distribution terminal operators, pipeline operators, truck/train/ship operators, wholesalers, gas stations, and customers. Different parties can use the functional architecture 200 to create and use blockchains 100 associated with terminal automation, drivers, vehicles, smart contracts, or other information about the supply chain.

As a particular example, part or all of an oil and gas supply chain can be moved to one or more consortium or other blockchains 100, where extraction, refining, terminal owners, and carrier companies could be the stakeholders. The blockchains 100 could then be used to support automated/transparent inventory tracking and exchange, as well as to support auditing. Moreover, smart contracts could be executed automatically based on real-time information, such as by charging customers appropriately based on an input crude oil's quality, taking action when a shareholder's stock moves above or below a specified limit, or automatically executing a comingling contract. In addition, cargo can be moved across terminals based on demand in a specified area. With respect to transfers of cargo out of terminals, the blockchains 100 could be used to track the movements of products from the terminals until reaching end customers and to execute smart contracts when applicable, such as for invoice generation related to custody transfers. Numerous parties could therefore benefit using blockchains 100, among other reasons by avoiding paper-based contracting and by improving the efficiency of supply chain management.

Any suitable blockchain technologies and nodes associated with those blockchain technologies can be used in the functional architecture 200. In some embodiments, for example, the ETHEREUM blockchain as a service can be used. In particular examples, the Nethereum web3 package can be used for blockchain interactions, Metamask can be used for ETHEREUM transfers, VISUAL STUDIO 2015 update 3 can be used for .Net application development, and MICROSOFT SOLIDITY and AZURE tool library integration can be used in VISUAL STUDIO 2015. Note, however, that other implementations are also possible. For instance, there are a number of blockchain technologies associated with cryptocurrencies that could be used (modified or unmodified) in the functional architecture 200.

Moreover, any suitable application or applications could be used by each party to interact with one or more blockchains 100. For example, an application could be used to create smart contracts, such as by using a driver identity, driver mapping, and transaction data, and to compile the smart contracts. Also, distributed applications could be used to connect to blockchains (such as by using Nethereum), unlock appropriate accounts, deploy the smart contracts into the blockchains, and submit transactions/execution of methods in the smart contracts. In addition, an application could be used support blockchain traversal for extracting transaction information (mining) and to display blocks, associated transactions, or other information in an intuitive user interface. Note that the same application could perform all of these functions, or different applications could be used to support different functions.

Although FIG. 2 illustrates one example of a functional architecture 200 for using blockchains supporting terminal automation solutions, various changes may be made to FIG. 2. For example, a consortium blockchain could be used by any number of consortium members, and each consortium leader/member could support any number of transaction nodes, mining nodes, and virtual gateways. Also, FIG. 2 illustrates one example operational environment in which blockchains can be used to support terminal automation solutions, and this functionality can be used in any other suitable system.

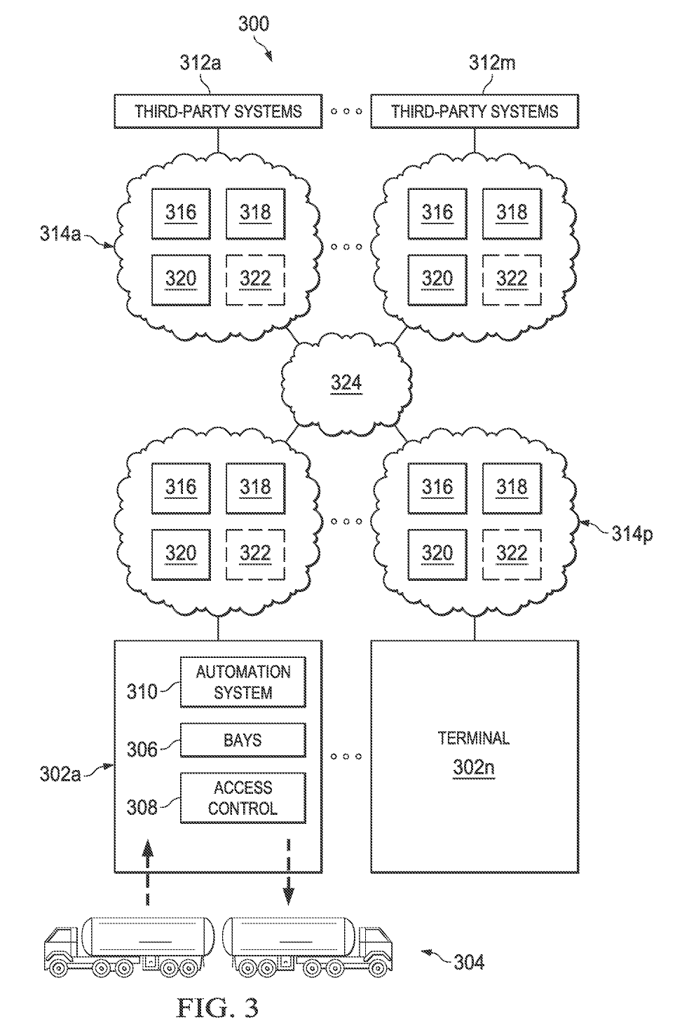

FIG. 3 illustrates an example system 300 of cargo distribution terminals that receive cargo from or provide cargo to a number of cargo vehicles in accordance with this disclosure. The system 300 here represents a specific example of the type of system where the functional architecture 200 shown in FIG. 2 could be used. However, the functional architecture 200 could be used in any other suitable system.

As shown in FIG. 3, the system 300 includes multiple cargo distribution terminals 302a-302n. Each cargo distribution terminal 302a-302n generally represents any suitable terminal used to receive, store, and distribute one or more products, such as petroleum products. Each cargo distribution terminal 302a-302n receives cargo from or provides cargo to a number of cargo vehicles 304, such as trucks, trains, or ships. The cargo could come from any number of sources and be delivered to any number of destinations. The cargo vehicles 304 may be associated with different carrier companies or other organizations.

In the example shown in FIG. 3, each of the cargo distribution terminals 302a-302n includes a number of bays 306, which denote areas or locations where the cargo vehicles 304 can travel. Each bay 306 could denote a portion of a warehouse, port, or other larger area where cargo can be loaded or unloaded. Each of the cargo distribution terminals 302a-302n may also include various access controls 308, which can be used to control which cargo vehicles 304 are allowed to enter or exit the cargo distribution terminal 302a-302n or a portion of the cargo distribution terminal 302a-302n. Any suitable access controls 308 could be used to allow personnel or cargo vehicles 304 to enter and exit a cargo distribution terminal or a portion thereof.

As noted above, due to the frequent arrival and departure of many cargo vehicles 304 and a limited number of cargo bays 306, some cargo distribution terminal 302a-302n have deployed terminal automation systems 310. The terminal automation systems 310 are typically designed to manage and schedule the loading and unloading of cargo involving numerous cargo vehicles 304. For example, each of the terminal automation systems 310 could generate schedules identifying when different cargo vehicles 304 are allowed to load or unload cargo in a cargo distribution terminal 302a-302n. Each of the terminal automation systems 310 could also track other information, such as information about drivers or vehicles.

If the terminal automation systems 310 are implemented using hardware devices and software solutions hosted locally, there may be little or no interactions between the automation systems 310 of different cargo distribution terminals 302a-302n. The lack of reliable communications between the automation systems 310 of different cargo distribution terminals 302a-302n can make it difficult to deal with a number of issues affecting cargo distribution. For example, cargo distribution terminals 302a-302n often face difficult challenges in dealing with product pilferage by vehicle drivers during the transportation of products from terminals 302a-302n to various destinations. As a particular example, assume that a single truck shipment involves 30,000 liters of fuel. A 0.1% pilferage would amount to 30 liters of lost fuel for that single shipment. A typical terminal might have 500 shipments of fuel per day, which could result in 35,000 liters of fuel loss per day. Monthly losses at this rate could amount to 450,000 liters of fuel, and this problem can be compounded to large annual operational losses across a single terminal or multiple terminals. This can result in huge monetary losses for terminal operators.

As another example, the lack of reliable communications between the automation systems 310 can make it difficult to detect drivers who engage in other misbehaviors that can lead to safety risks and revenue losses to the terminals. For instance, drivers who delay loading or unloading processes by not following appropriate standard operating procedures (SOPs) for a terminal can reduce the throughput of the terminal, such as when every 30 minutes of delay is equivalent to missing one full shipment of product. Incidents involving more critical safety issues could result in the shutdown and downtime of much longer durations in a terminal, resulting in even more significant monetary losses. Drivers and vehicles are often not flagged for such misbehaviors. Even if a particular driver or vehicle is identified for wrongdoing, this awareness is usually limited to a local terminal only and is not passed on to other terminals so that the same set of practices can be avoided.

As yet another example, one or more customers could hold the same type of product in the same tank or different tanks of a terminal. In some cases, customers could also hold products across multiple terminals. Obtaining information regarding stock availability for particular customers can be a challenge, particularly in the case of comingling tanks in the above-mentioned scenarios. Tank readings are normally read at the start of a day/shift, and reconciliations are performed at the close of the day/shift. Obtaining a current “on demand” stock availability for particular customers can be difficult for terminals.

As described in this patent document, the terminal automation systems 310 of different cargo distribution terminals 302a-302n can be configured to use blockchains to support information exchanges between the terminals 302a-302n. Various third-party systems 312a-312m may also be used in the system 300 and support the use of blockchains. The third-party systems 312a-312m could denote data processing systems used by parties associated with cargo or the distribution terminals 302a-302n. Example third-party systems 312a-312m could include computing systems used by governmental entities, product producers, cargo carriers, product distributors, and end customers. In general, any stakeholder associated with cargo being transported or distributed could have an associated third-party system 312. Example third-party systems 310a-310m could also include a computing system that is used by a party hosting or overseeing the use of one or more blockchains, such as a consortium leader 202. As a specific example, a company that is unrelated to the terminals and other third parties could host or oversee the use of one or more blockchains.

Assume that at least one consortium blockchain is used in FIG. 3. A consortium blockchain can be established by one of the parties in FIG. 3, and other parties in FIG. 3 can be allowed to join the consortium blockchain. Each party can own, use, or otherwise have access to a computing cloud 314a-314p, which generally represents one or more computing devices executing functions on behalf of the associated party. Often times, the computing clouds 314a-314p represent computing clouds leased, rented, or otherwise used (but not owned) by the parties in FIG. 3 (although this need not be the case). Various companies offer computing cloud services, such as MICROSOFT's AZURE, IBM's BLUE MIX, and AMAZON's AWS. Depending on the implementation, at least some of the computing clouds 314a-314p shown in FIG. 3 could denote different portions of the same computing cloud. It is also possible that at least some of the computing clouds 314a-314p shown in FIG. 3 could denote different portions of different computing clouds.

Within each computing cloud 314a-314p, the associated party has one or more transaction nodes 316, one or more mining nodes 318, and optionally one or more load balancing nodes 320. While not shown here, the associated party could also have one or more virtual gateways within each computing cloud 314a-314p. These components may be the same as or similar to the corresponding components described above with respect to FIG. 2. These components support the use of one or more blockchains 322 by the consortium members. The transaction nodes 316 generally operate to receive transaction data (such as actual transaction data or metadata) and to provide the transaction data to the mining nodes 318. The mining nodes 318 generally operate to create new blocks for the transactions and to publish the new blocks for addition to the blockchains 322. The mining nodes 318 could be responsible for obtaining consensus for adding blocks to the blockchains 322, verifying ownership using the blockchains 322, or performing any other suitable functions. Establishing consensus could occur in any suitable manner. The load balancing nodes 320 generate operate to distribute transactions to the transaction nodes 316 and/or the mining nodes 318 if a large number of transactions are envisioned. If not, the load balancing nodes 320 can be omitted. Each of the nodes 316-320 could be implemented in any suitable manner. For instance, each of the nodes 316-320 could represent a virtual node or virtual machine executed in a computing cloud. The blockchains 322 could be implemented as described above with respect to FIG. 1, or other blockchain forms could be used.

If needed, at least one network 324 can be used to couple the computing clouds 314a-314p. The network 324 facilitates communications between various components in the system 300. For example, the network 324 may communicate Internet Protocol (“IP”) packets or other information between network addresses. The network 324 could support communications over any suitable physical or wireless connections. The network 324 may include one or more local area networks (“LANs”), metropolitan area networks (“MANs”), wide area networks (“WANs”), all or a portion of a global network such as the Internet, or any other communication system or systems at one or more locations.

In some embodiments, the leader of a consortium blockchain can connect member subnetworks (the computing clouds 314a-314p in this example) by configuring virtual network settings to connect the members over the network 324. The leader and the other members can then host the transaction nodes 316, which could receive new blockchain content, such as from distributed applications (DAPPs). The transaction nodes 316 can provide the new blockchain content to the mining nodes 318 for insertion into the blockchains 322. In particular embodiments, all transaction nodes 316 could be accessible over a specified port or ports using a secure protocol, such as SSH, and the mining nodes 318 could be shielded so they cannot be accessed remotely.

Blockchains 322 can be used for various purposes in the system 300. This includes end-to-end supply chain optimization using a consortium blockchain for custody transfers. Among other things, blockchains 322 can be used to represent products being loaded, unloaded, and stored in the cargo distribution terminals 302a-302n. This can be done to support the digital tracking of product transfers between various parties, extended stock reconciliation, and integration with payments and receipt generations in real-time. Blockchains 322 could also be associated with drivers or vehicles and used to support digital identity management for vehicles/drivers across different terminals. Blockchains 322 could further be used to support the creation, compilation, and deployment of smart contracts and to track transactions associated with the smart contracts.

As particular examples, the various parties involved in cargo distribution can use blockchains 322 to support a number of functions. For instance, driver/vehicle performance data and digital identities can be shared among the terminals 302a-302n using one or more blockchains 322. This information could then be used to restrict “bad actors” from entering into all of the terminals 302a-302n. This can help to reduce product pilferage, increase safety of the operating environment within the terminals, or ensure delivery of products with a higher grade of accuracy to intended destinations. The use of blockchain technology also helps the terminal operators to know that valid information is being received from other terminal operators. As another example, customers can interact with terminals using blockchains 322 to receive immediate notifications directly from the terminals regarding products being shipped. This helps the customers to make proactive decisions, such as when making new exchange agreements based on their demand and supply variations across terminals.

Although FIG. 3 illustrates one example of a system 300 of cargo distribution terminals that receive cargo from or provide cargo to a number of cargo vehicles, various changes may be made to FIG. 3. For example, the system 300 could include any number of terminals, third-party systems, nodes, blockchains, and other components. Also, the makeup and arrangement of the system 300 in FIG. 3 is for illustration only. Components could be added, omitted, combined, or placed in any other suitable configuration according to particular needs. In addition, FIG. 3 illustrates one example operational environment in which blockchains can be used with cargo terminals. This functionality can be used in any other suitable system.

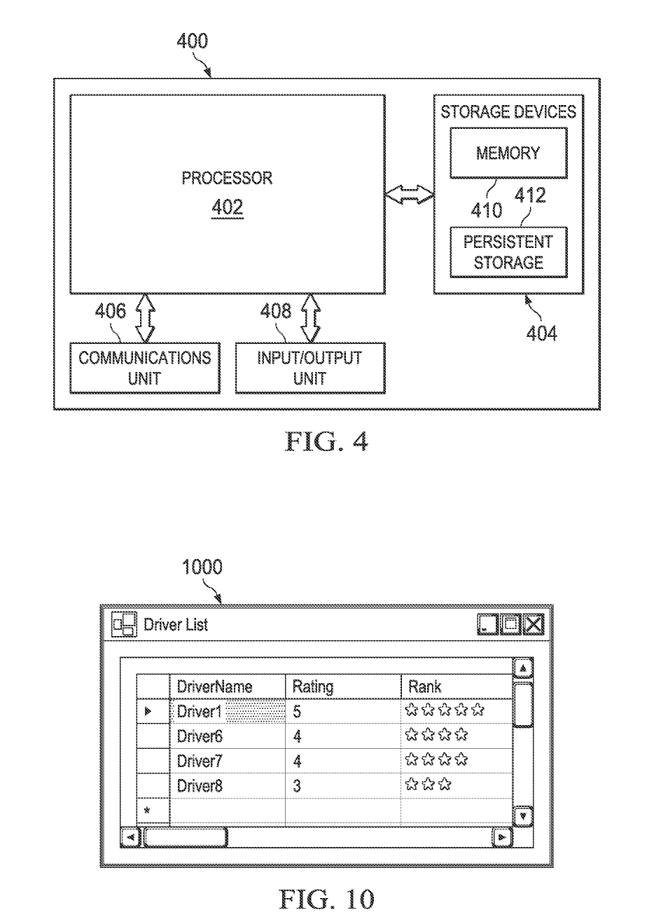

FIG. 4 illustrates an example device 400 supporting blockchain technology for terminal automation solutions in accordance with this disclosure. The device 400 could, for example, represent computing devices implementing one or more transaction nodes 206, one or more mining nodes 208, and/or one or more virtual gateways 210 shown in FIG. 2 and described above that might use blockchains. The device 400 could also represent any of the terminal automation systems 310, third-party systems 312, devices in computing clouds 314a-314p, or other components shown in FIG. 3 and described above that might use blockchains.

As shown in FIG. 4, the device 400 includes at least one processor 402, at least one storage device 404, at least one communications unit 406, and at least one input/output (“I/O”) unit 408. Each processor 402 can execute instructions, such as those that may be loaded into a memory 410. For example, the instructions can implement various functions described in this document for using blockchain technology. Each processor 402 denotes any suitable processing device, such as one or more microprocessors, microcontrollers, digital signal processors, application specific integrated circuits (“ASICs”), field programmable gate arrays (“FPGAs”), or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. For example, the communications unit 406 could include at least one network interface card or wireless transceiver facilitating communications over at least one wired or wireless network. The communications unit 406 may support communications through any suitable physical or wireless communication link(s).

The I/O unit 408 allows for input and output of data. For example, the I/O unit 408 may provide a connection for user input through a keyboard, mouse, keypad, touchscreen, or other suitable input device. The I/O unit 408 may also send output to a display, printer, or other suitable output device.

Although FIG. 4 illustrates one example of a device 400 supporting blockchain technology for terminal automation solutions, various changes may be made to FIG. 4. For example, components could be added, omitted, combined, further subdivided, or placed in any other suitable configuration according to particular needs. Also, computing devices can come in a wide variety of configurations, and FIG. 4 does not limit this disclosure to any particular configuration of computing device.

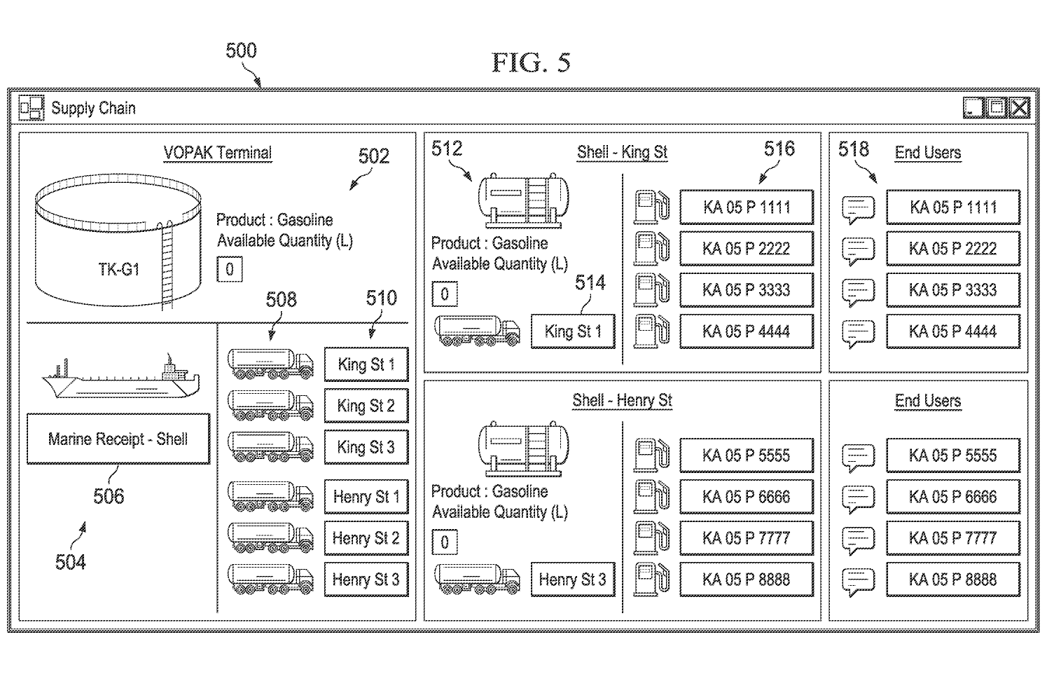

FIGS. 5 through 10 illustrate example graphical user interfaces based on blockchains supporting terminal automation solutions in accordance with this disclosure. For ease of explanation, the graphical user interfaces may be described as being generated by the processor 402 of the device 400 in FIG. 4, which could be used in the functional architecture 200 of FIG. 2 or the system 300 of FIG. 3. However, the graphical user interfaces could be generated by any suitable devices and in any suitable systems.

As shown in FIG. 5, a graphical user interface 500 identifies a supply chain for gasoline and provides information about the transport of the gasoline in the supply chain. In this example, a section 502 of the graphical user interface 500 identifies a specific tank of a distribution terminal. The section 502 also provides information about the tank, such as the product (gasoline) stored in the tank and a quantity of the product stored in the tank. A section 504 of the graphical user interface 500 identifies one or more sources for the product stored in the tank. In this example, the section 504 indicates that the gasoline stored in the identified tank was provided by a marine vessel, and the section 504 includes a button 506 that allows a user to view information about the receipt of the gasoline from the marine vessel. A section 508 of the graphical user interface 500 identifies one or more destinations for the product stored in the tank. In this example, the section 508 indicates that the gasoline stored in the identified tank has been, is being, or will be delivered to multiple destinations (gas stations) using different trucks. The section 508 includes a button 510 for each truck that allows a user to view information about the shipment of the product in the associated truck.

The graphical user interface 500 also includes one or more sections 512, where each section 512 is associated with a different customer who has received, is receiving, or will be receiving the product stored in the identified tank. In this example, each section 512 identifies a gasoline storage tank at a specific gas station. Each section 512 also includes a button 514 associated with a truck used to deliver the product to that customer. Selection of the button 514 allows a user to view information about the receipt of the product in the associated truck. Each section 512 may optionally include one or more buttons 516 associated with individual pumps associated with the gas station, which could be selected to view information about that specific pump (such as use of the product by that pump). The graphical user interface 500 may further optionally include a section 518 containing one or more buttons that could be selected to view information provided by end users, such as customer reviews of the gas station.

The information used to generate the graphical user interface 500 can be inserted into one or more blockchains 100, 322 by any suitable entity or entities, and that information can then be mined from the blockchain(s) 100, 322 to generate the graphical user interface 500. For example, an owner or operator of a distribution terminal could use a device 400 having a processor 402 that inserts blocks into the blockchain(s) 100, 322 related to the tank, the product stored in the tank, the cargo vehicle(s) that delivered the product in the tank, and the cargo vehicle(s) that shipped the product from the tank. An owner or operator of each gas station could use a device 400 having a processor 402 that inserts blocks into the blockchain(s) 100, 322 related to the receipt and use of the product. A third-party system could include a processor 402 that inserts blocks into the blockchain(s) 100, 322 related to end users.

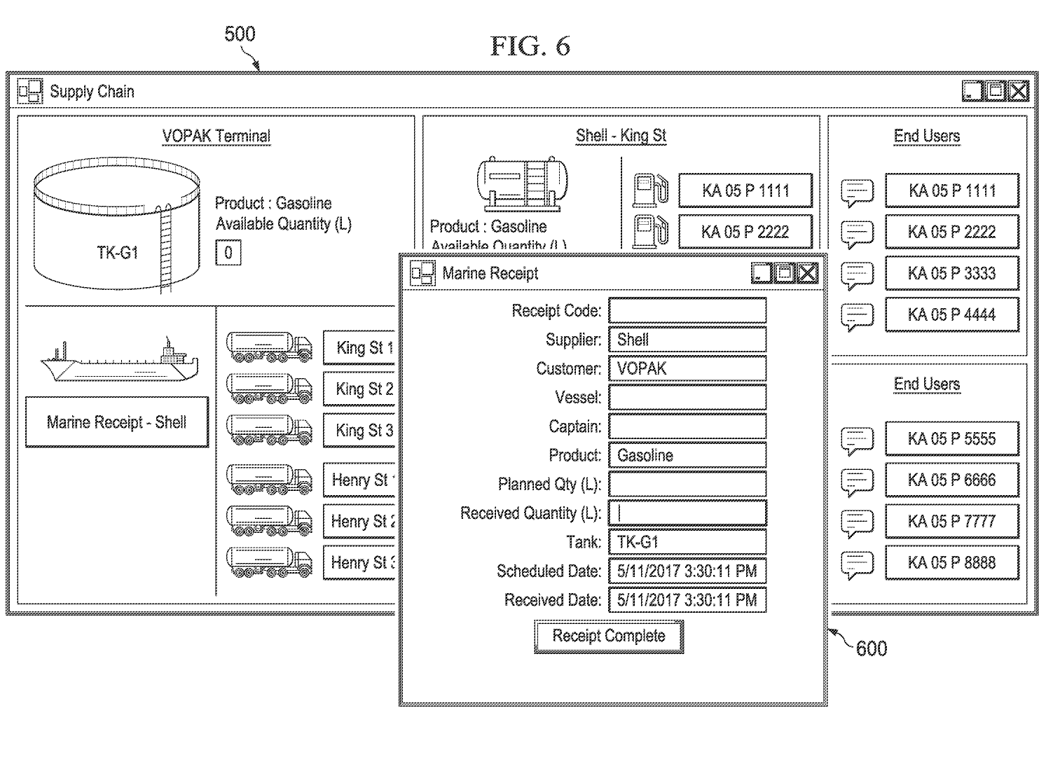

As shown in FIG. 6, a user has selected the button 506, causing a pop-up window 600 to be displayed over the graphical user interface 500. The pop-up window 600 presents various information about one or more cargo vehicles that provided the product stored in the identified tank. In this example, the pop-up window 600 includes a field identifying a receipt code, which could vary depending on how the product in the tank was received. The pop-up window 600 also includes fields identifying a supplier of the product and a customer of the product. In this example, since the source was a marine vessel, the pop-up window 600 further includes fields identifying the marine vessel and a captain of the vessel. Moreover, the pop-up window 600 includes fields identifying the actual product, the quantity of product that was supposed to be received, and the quantity of product that was actually received. In addition, the pop-up window 600 includes fields identifying the tank containing the product, the scheduled delivery date for the product, and the actual delivery date for the product. It should be noted that these fields are examples only and that any other or additional fields could be provided to store information about a product. One or more of these fields could be filled in or edited by a user, and any additions or changes could be included in one or more new blocks added to the appropriate blockchain(s) 100, 322.

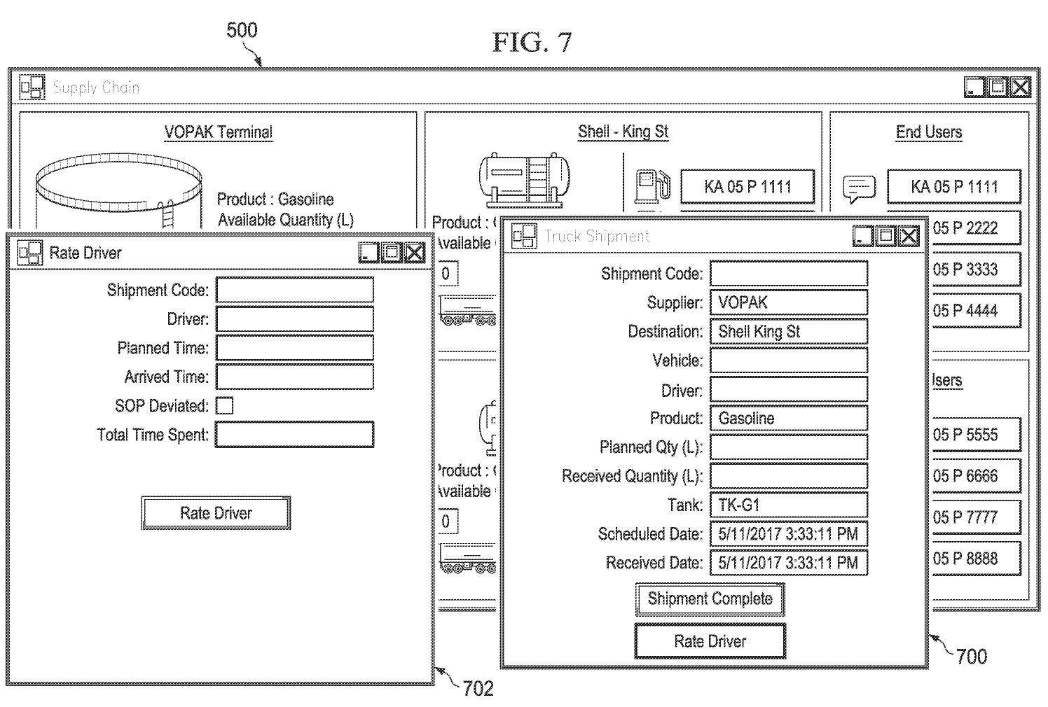

As shown in FIG. 7, a user has selected one of the buttons 510 in the graphical user interface 500, causing a pop-up window 700 to be displayed over the graphical user interface 500. The pop-up window 700 presents various information about one or more cargo vehicles used to transport the product from the identified tank. In this example, the pop-up window 700 includes a field identifying a shipment code, which could vary depending on how the product in the tank is being transported. The pop-up window 700 also includes fields identifying a supplier of the product and a destination for the product. In this example, since the product is being transported by truck, the pop-up window 700 further includes fields identifying a vehicle and a driver of the vehicle. Moreover, the pop-up window 700 includes fields identifying the actual product, the quantity of product that was supposed to be shipped, and the quantity of product that was actually shipped. In addition, the pop-up window 700 includes fields identifying the tank that previously contained the product, the scheduled shipment date for the product, and the actual shipment date for the product. It should be noted that these fields are examples only and that any other or additional fields could be provided to store information about a product shipment. One or more of these fields could be filled in or edited by a user, and any additions or changes could be included in one or more new blocks added to the appropriate blockchain(s) 100, 322.

The pop-up window 700 here includes a button that allows a user to rate the driver associated with the shipment. This may allow, for example, a user associated with a terminal to provide information about whether the driver deviated from standard operating procedures or caused other problems during loading of cargo onto a vehicle. Selection of this button causes a pop-up window 702 to be displayed over the graphical user interface 500. The pop-up window 702 here includes fields identifying the shipment code and driver for the delivery, which may or may not be auto-populated based on the contents of the pop-up window 700. The pop-up window 702 also includes fields identifying the planned arrival time and actual arrival time of the driver for loading of the cargo. In addition, the pop-up window 702 includes fields identifying whether the driver deviated from standard operating procedures and the total time spent by the driver during the cargo loading. It should be noted that these fields are examples only and that any other or additional fields could be provided to store information about a driver. One or more of these fields could be filled in or edited by a user, and any additions or changes could be included in one or more new blocks added to the appropriate blockchain(s) 100, 322.

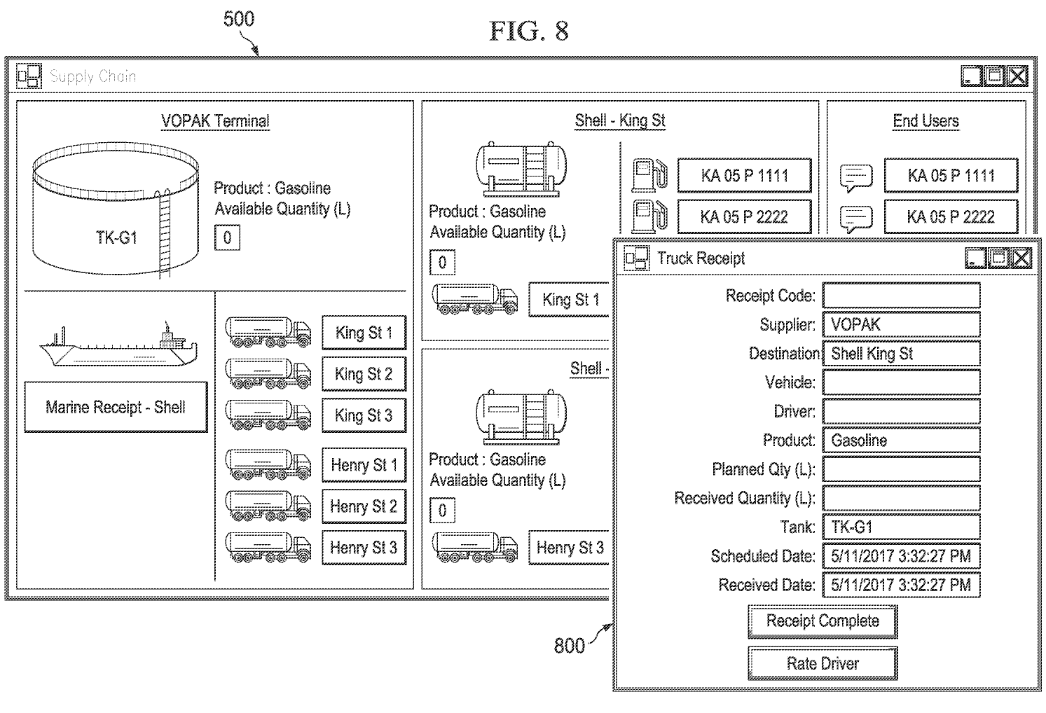

As shown in FIG. 8, a user has selected one of the buttons 514 in the graphical user interface 500, causing a pop-up window 800 to be displayed over the graphical user interface 500. The pop-up window 800 presents various information about a specific delivery of the product stored in the identified tank. In this example, the pop-up window 800 includes a field identifying a receipt code, which could vary depending on how the product in the tank is delivered. The pop-up window 800 also includes fields identifying a supplier of the product and a destination for the product. In this example, since the product is being delivered by truck, the pop-up window 800 further includes fields identifying the vehicle and a driver of the vehicle. Moreover, the pop-up window 800 includes fields identifying the actual product, the quantity of product that was supposed to be received, and the quantity of product that was actually received. In addition, the pop-up window 800 includes fields identifying the tank that previously contained the product, the scheduled delivery date for the product, and the actual delivery date for the product. It should be noted that these fields are examples only and that any other or additional fields could be provided to store information about a product delivery. One or more of these fields could be filled in or edited by a user, and any additions or changes could be included in one or more new blocks added to the appropriate blockchain(s) 100, 322. While not shown here, a user could elect to rate a driver by selecting the appropriate button in the pop-up window 800, which would present the pop-up window 702 described above. The user could then provide information such as the planned delivery time, the actual delivery time, whether standard operating procedures were followed during the delivery, and the total time required for the delivery.

As can be seen in FIGS. 5 through 8, one or more blockchains can be used to track the expected and actual quantities of one or more products being transported and delivered. It can therefore be easily determined whether particular personnel like a specific driver is routinely delivering less product than expected, which could be indicative of product pilferage. It is also possible for governmental authorities to see whether a product distributor is reporting correct quantities of products for tax purposes. Various other functions could be performed using the data presented in the graphical user interface 500 or the associated pop-up windows.

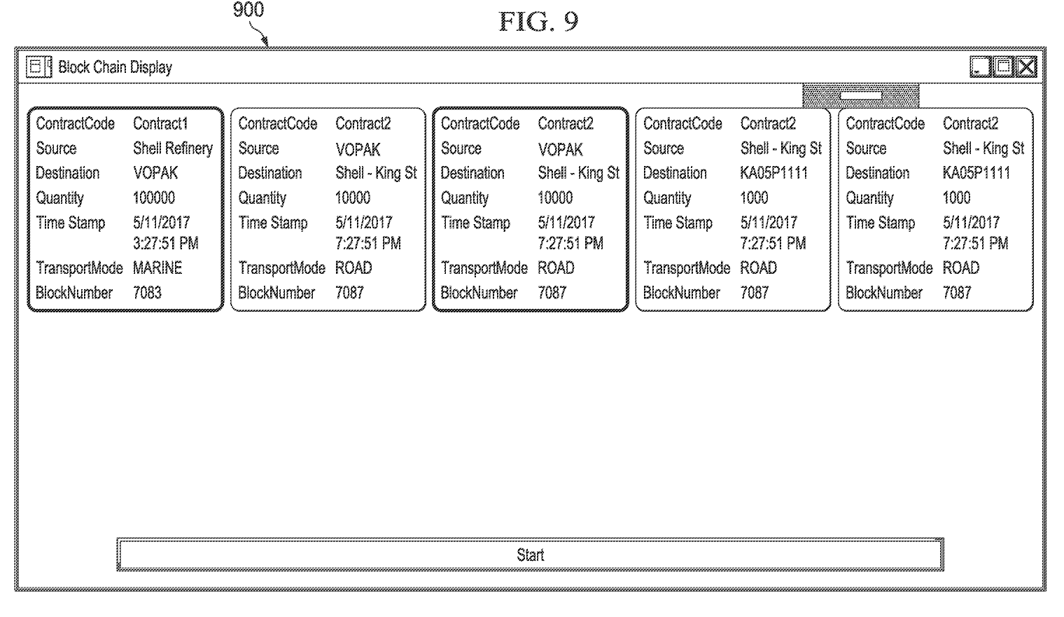

As shown in FIG. 9, a graphical user interface 900 can be used to present the results of mining one or more blockchains 100, 322 in order to identify one or more blocks of the blockchain(s). The criteria for mining blocks from the one or more blockchains 100, 322 could be identified in any suitable manner. For example, a user could invoke a function using the graphical user interface 500 to mine the appropriate blockchain(s) for entries related to something displayed in the graphical user interface 500. Alternatively, a user could enter the criteria in the graphical user interface 900 and select a “start” button to initiate mining. However the criteria is entered, blocks that are identified as matching the search criteria can be identified in the graphical user interface 900, and at least some of the contents of the blocks can be displayed in the graphical user interface 900.

As shown in FIG. 10, a graphical user interface 1000 can be generated by mining one or more blockchains 100, 322 and identifying ratings for various drivers identified in the blockchain(s). As noted earlier, information about drivers is typically not shared between different terminals or between terminals and carrier companies that employ the drivers. It is therefore often difficult to validate the genuineness of a driver or a vehicle with respect to terminal operations. Drivers and vehicles often have to register themselves with multiple terminals independently, resulting in terminal-specific driver and vehicle inventory and validation. Good or bad activities of a driver or vehicle in one terminal are not visible to others.

As a result, one or more blockchains 100, 322 could be used for driver or vehicle identity management. Information about each driver stored in the blockchain(s) could include the driver's name and date of birth, driver's license expiration date, carrier company, and any specialty training (like health, safety, and environment or “HSE” training). Multiple terminal owners and carrier companies could be the stakeholders of the blockchains. The blockchains could also optionally be used by one or more governmental entities, such as state or federal transportation departments for license validation or other functions. Driver or vehicle identities can be maintained in the blockchain(s) along with a history of their activities. The history can identify on-time arrivals, their times taken in terminals, theft complaints, fleet management (such as tracking or detour information), and vehicle maintenance details and inspection details. Rating of the drivers could then be generated based on their histories and other information.

The rating information could be used in any suitable manner. For example, terminal owners or operators could incentivize drivers with good driver ratings by placing them in priority queues for picking up or dropping off cargo. Also, terminal owners or operators could blacklist drivers who deviate from standard operating procedures a specified number of times and reject entry of those drivers into the terminals. This can help to promote safer and more effective operations and to protect multiple terminals, even those that have not witnessed unsafe driver behaviors.

Although FIGS. 5 through 10 illustrate examples of graphical user interfaces based on blockchains supporting terminal automation solutions, various changes may be made to FIGS. 5 through 10. For example, the graphical user interfaces shown in FIGS. 5 through 10 are merely examples of specific ways in which blockchains supporting terminal automation solutions could be used. Any suitable graphical user interfaces could be used to present information based on blockchains that support terminal automation solutions. Also, blockchains supporting terminal automation solutions could be used in other ways and need not be used to generate graphical user interfaces.

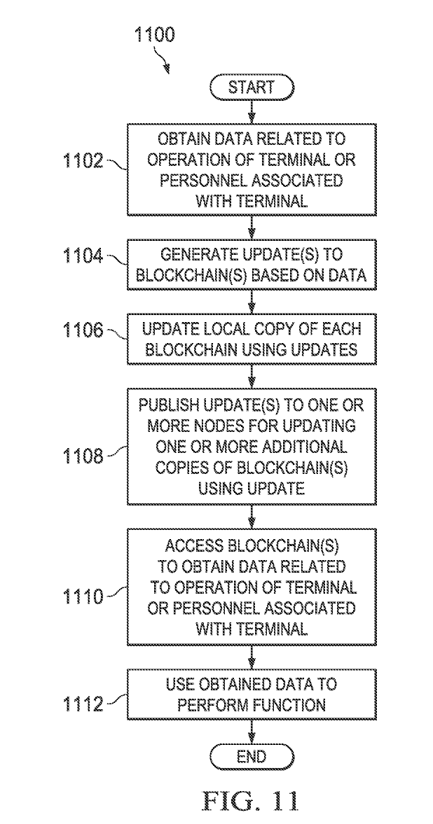

FIG. 11 illustrates an example method 1100 for using blockchains to support terminal automation solutions in accordance with this disclosure. For ease of explanation, the method 1100 is described as involving the use of one or more devices 400 from FIG. 4 in the functional architecture 200 of FIG. 2. However, the method 1100 could be used with any other suitable devices and in any other suitable systems.

As shown in FIG. 11, data related to (i) operation of a cargo terminal and/or (ii) personnel associated with the cargo terminal is obtained at step 1102. This could include, for example, a processor 402 executing or implementing a transaction node 206 to receive transaction-related data (such as complete descriptions or metadata) from at least one data source. This could also include passing the data to a processor 402 executing or implementing at least one mining node 208. Note that the same processor 402 could execute both nodes, or different processors 402 could be used. The data source(s) could represent any suitable source(s) of information. The data could relate to actual products being stored in or distributed from a terminal, shipments and receipts of the products, drivers of vehicles or other operators of cargo vehicles transporting the products, or other information.

At least one update to at least one blockchain is generated based on the data at step 1104, and a local copy of the blockchain(s) is updated using the at least one update at step 1106. This could include, for example, the processor 402 executing or implementing the mining node 208 to generate one or more blocks 102 to be added to one or more blockchains 100. This could also include the processor 402 executing or implementing the mining node 208 to insert each new block 102 into the appropriate blockchain 100. Each block 102 could have the form shown in FIG. 1 and could contain a link back to a previous block 102 (such as the previous block's root hash value 110) to help secure the blockchain 100. In some embodiments, the mining node 208 could interact with other mining nodes 208 in order to determine whether the addition of a new block 102 to a blockchain 100 is allowed. The at least one update is also published to one or more other nodes for updating one or more additional copies of the blockchain(s) at step 1108. This could include, for example, the processor 402 executing or implementing the mining node 208 to transmit each new block 102 to one or more other mining nodes 208. This could also include the processor 402 executing or implementing each of the other mining nodes 208 to insert each new block 102 into the appropriate blockchain 100.

The steps 1102-1108 could be repeated any number of times by any number of nodes to support the use of at least one blockchain 100 containing terminal automation-related data. Each blockchain 100 could include only several blocks 102 or a large number of blocks 102. Each blockchain 100 could also be used in any suitable manner. For example, one or more blockchains could be accessed in order to obtain data associated with terminal operations or personnel at step 1110, and the data could be used to perform at least one function at step 1112. This could include, for example, a computer system accessing at least one blockchain 100 to obtain information about the products being stored in or distributed from a terminal, such as to perform real-time reconciliation of products. This could also include a computer system accessing at least one blockchain 100 to obtain information about a specific driver or other cargo vehicle operator and using the information to grant/deny terminal access to the vehicle operator. This could further include a computer system accessing at least one blockchain 100 to obtain information and generating one or more graphical user interfaces. Any other or additional actions could occur using one or more blockchains containing information about terminal operations or related personnel.

Although FIG. 11 illustrates one example of a method 1100 for using blockchains to support terminal automation solutions, various changes may be made to FIG. 11. For example, while shown as a series of steps, various steps in FIG. 11 could overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products;
generating an update to a blockchain based on the data;
updating a local copy of the blockchain using the update; and
publishing the update to one or more nodes for updating one or more additional copies of the blockchain.

2. The method of claim 1, wherein:
the data is associated with the one or more products stored in or transferred via the first cargo distribution terminal; and
the update to the blockchain identifies that at least a portion of the one or more products has been received at or shipped from the first cargo distribution terminal.

3. The method of claim 2, wherein:
the update to the blockchain identifies (i) at least one quantity of the one or more products actually shipped from the first cargo distribution terminal and (ii) at least one quantity of the one or more products that was expected to be shipped from the first cargo distribution terminal; and
another update to the blockchain identifies (i) at least one quantity of the one or more products actually received from the first cargo distribution terminal and (ii) at least one quantity of the one or more products that was expected to be received from the first cargo distribution terminal.

4. The method of claim 1, wherein:
the data is associated with a vehicle used to transport the one or more products or a driver of the vehicle; and
the update to the blockchain identifies information about the vehicle or the driver.

5. The method of claim 4, further comprising:
granting or denying access to the first cargo distribution terminal or a portion thereof or to a second cargo distribution terminal or a portion thereof based on the information about the vehicle or the driver in the blockchain.

6. The method of claim 4, wherein the information about the vehicle or the driver comprises:
expected and actual arrival times of the vehicle;
an indication whether the driver followed at least one standard operating procedure during a pick-up or delivery of the one or more products; and
a total time spent by the driver during the pick-up or delivery of the one or more products.

7. The method of claim 1, wherein publishing the update allows a second cargo distribution terminal to obtain information about the update.

8. The method of claim 1, wherein publishing the update comprises transmitting the update to a third-party system.

9. An apparatus comprising:
at least one memory configured to store data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products; and
at least one processor configured to:
generate an update to a blockchain based on the data;
update a local copy of the blockchain using the update; and
publish the update to one or more nodes for updating one or more additional copies of the blockchain.

10. The apparatus of claim 9, wherein:
the data is associated with the one or more products stored in or transferred via the first cargo distribution terminal; and
the update to the blockchain identifies that at least a portion of the one or more products has been received at or shipped from the first cargo distribution terminal.

11. The apparatus of claim 10, wherein:
the update to the blockchain identifies (i) at least one quantity of the one or more products actually shipped from the first cargo distribution terminal and (ii) at least one quantity of the one or more products that was expected to be shipped from the first cargo distribution terminal; and
the at least one processor is configured to generate or receive another update to the blockchain that identifies (i) at least one quantity of the one or more products actually received from the first cargo distribution terminal and (ii) at least one quantity of the one or more products that was expected to be received from the first cargo distribution terminal.

12. The apparatus of claim 9, wherein:
the data is associated with a vehicle used to transport the one or more products or a driver of the vehicle; and
the update to the blockchain identifies information about the vehicle or the driver.

13. The apparatus of claim 12, wherein the at least one processor is further configured to grant or deny access to the first cargo distribution terminal or a portion thereof or to a second cargo distribution terminal or a portion thereof based on the information about the vehicle or the driver in the blockchain.

14. The apparatus of claim 12, wherein the information about the vehicle or the driver comprises:
expected and actual arrival times of the vehicle;
an indication whether the driver followed at least one standard operating procedure during a pick-up or delivery of the one or more products; and
a total time spent by the driver during the pick-up or delivery of the one or more products.

15. A non-transitory computer readable medium containing instructions that when executed cause at least one processor to:
obtain data associated with at least one of: (i) one or more products stored in or transferred via a first cargo distribution terminal, (ii) one or more actions occurring in the first cargo distribution terminal, and (iii) one or more personnel associated with the first cargo distribution terminal or the one or more products;
generate an update to a blockchain based on the data;
update a local copy of the blockchain using the update; and
publish the update to one or more nodes for updating one or more additional copies of the blockchain.

16. The non-transitory computer readable medium of claim 15, wherein:
the data is associated with the one or more products stored in or transferred via the first cargo distribution terminal; and
the update to the blockchain identifies that at least a portion of the one or more products has been received at or shipped from the first cargo distribution terminal.

17. The non-transitory computer readable medium of claim 16, wherein:
the update to the blockchain identifies (i) at least one quantity of the one or more products actually shipped from the first cargo distribution terminal and (ii) at least one quantity of the one or more products that was expected to be shipped from the first cargo distribution terminal; and
the medium further contains instructions that when executed cause the at least one processor to generate or receive another update to the blockchain that identifies (i) at least one quantity of the one or more products actually received from the first cargo distribution terminal and (ii) at least one quantity of the one or more products that was expected to be received from the first cargo distribution terminal.

18. The non-transitory computer readable medium of claim 16, wherein:
the data is associated with a vehicle used to transport the one or more products or a driver of the vehicle; and
the update to the blockchain identifies information about the vehicle or the driver.

19. The non-transitory computer readable medium of claim 18, further containing instructions that when executed cause the at least one processor to grant or deny access to the first cargo distribution terminal or a portion thereof or to a second cargo distribution terminal or a portion thereof based on the information about the vehicle or the driver in the blockchain.

20. The non-transitory computer readable medium of claim 18, wherein the information about the vehicle or the driver comprises:
expected and actual arrival times of the vehicle;
an indication whether the driver followed at least one standard operating procedure during a pick-up or delivery of the one or more products; and
a total time spent by the driver during the pick-up or delivery of the one or more products.
